(19) United States
(12) Patent Application Publication
(10) Pub. No.: US 2007/0272244 A1
(43) Pub. Date: Nov. 29, 2007

(54) Fluidic barrier

(76) Inventor: Warner Harry Witmer, Phoenixville, PA (US)

Correspondence Address: WARNER WITMER, 306 VISTA DRIVE, PHOENIXVILLE, PA, 19460, US

(21) Appl. No.: 11/410,371

(22) Filed: Apr. 25, 2006

(51) Int. Cl. A62B 18/02

(52) U.S. Cl. 128/205.25

(57) ABSTRACT

The invention relates to a method for providing a mini/microenvironment, separating a determined zone from a surrounding space while providing said zone a window access opening without loss of protection against hazardous agents either entering or leaving the protected zone. More particularly, an embodiment describes personal respiratory protection provided against hazardous airborne particulates and pathogens without the requirement of a solid barrier over the oral-nasal portion of the face. High breathing resistance, impaired voice communication, thermal stress, and uncomfortable straps holding a mask tightly over the mouth and nose are eliminated. Thereby, considerable increased comfort during long-term use is realized without compromising protection.

### FIELD OF THE INVENTION

Generally, this invention relates to separation of a determined atmosphere zone from a surrounding space. More specifically, the invention relates to both minienvironments and microenvironments allowing safe unobstructed access to a conditioned space while disallowing both ingress or egress of hazardous agents.

### BACKGROUND OF THE INVENTION

Often a determined zone must provide protection against hazardous agents entering from the outside space environment. These are sometimes called minienvironments. For example, an immunologically compromised patient may be placed in a hospital respiratory isolation room designed to provide positive inside pressure so as to protect the patient from ingress of outside contaminants.

Sometimes it is critical that no hazardous agents inside the minienvironment be allowed egress to the outside. A patient with a highly communicable respiratory infection, for example, may be placed in a hospital respiratory isolation room designed to provide negative inside pressure so as to prevent egress of respiratory infectious contaminants.

Microenvironments are often provided so that an individual may leave an area free of airborne hazards to enter an area where possible hazardous respiratory particulates are in the air. For example, during a pandemic a person may have to leave an area free of airborne hazards to enter an area where possible highly contagious respiratory viral particulates may be in the air as when an individual may have to leave his home to go to a grocery store where people may congregate. As another example, a fireman may have to leave the protective environment of his fire station to enter an area where hazardous smoke particulates are present to aid putting out a fire. A medical doctor may wish to leave a safe environment to confer with a patient who has a known communicable respiratory condition. A laboratory worker may want to enter an area where possible particulate toxicity is present. A protective environment of this type for personal respiratory protection will be called a “microenvironment”.

Microenvironments are often required to provide a conditioned environment for individual use. Military personnel during warfare require respiratory protection from hazardous poisonous gases and toxic materials. Military vehicle crews require respiratory protection within the limited crew space of vehicle systems. Fire personnel require respiratory protection. Laboratory personnel, working with hazardous materials, require respiratory tract, eye, and skin protection from exposure to such agents.

A terrorist act of violence of biological or chemical nature requires respiratory protection for rescue individuals entering a zone where they will be exposed to toxic conditions. Today there is increasing interest both from governmental agencies and the general public for protecting individuals from respiratory transmission of viral particulates in the event of endemic influenza pandemic. More generally, NBC (Nuclear, Biological, Chemical) protection is required.

Both government and industry have set standards for personal respiratory protection. Studies have been made and filtration developed to enable a worker to function in contaminated air with relative safety by the use of facemasks, hoods, and special clothing. However, generally such microenvironments are uncomfortable for the user, especially if worn for long times. Thus, due to discomfort and restrictiveness respiratory equipments of this type are worn only when absolutely necessary. Consequently, the discomfort problem particularly hazards the effectiveness of microenvironments.

In the event of sudden or unexpected toxic or noxious environment it is clearly advantageous to have immediate effective respiratory protection from outside liquids/droplets, particles, fine sprays, aerosols, viral and bacterial pathogens, and gases of hazardous nature. A major requirement of microenvironmental apparatus then is that they can be donned quickly and worn for prolonged periods, especially by untrained civilians. Fast access to protective equipment is required because many hazardous incidents occur with little or no warning.

Particulates

In common, NBC hazards plus viral, bacterial and toxin infectious pathogens are particulates. These particulates float around in the air and mainly induce respiratory illness by entering the nasal passages. A post-nuclear incident, for example, often involves radioactive particulates that must not be inhaled or ingested. It is therefore essential that inventive apparatus of the mini/microenvironmental type deal with avoidance of particulates.

It is interesting to view infectious respiratory hazards of viral, bacterial, and endogen types as particulates. Table I reviews the relative general transmission risk of some human transmitted viral infections. These type infectious particulates are mostly above 0.1 microns in size. None are less than 0.01 μm in size. It is an overall objective of the present invention to assure infectious particulate isolation of size corresponding to the pathogenic particulates detailed in Tables (1) and (2).

TABLE 1

| | | Susceptibility | Resultant |
|---|---|---|---|
| | Trans- | of staff or | Noscomial |
| Virus | missibility | patient | Risk |
| Respiratory | High | Variable | High |
| Viruses- Influenza | | | |
| Respiratory | High | High | High |
| Synaztea | | | |
| Rhinovirus | Moderate | Moderate | Moderate |
| Other | Moderate | Moderate | Moderate |
| (adenovirus, | | | |
| caronavirus) | | | |
| Varicalla | High | Very low | Low |
| (chicken pox) | | | |
| Herpes- Zoster | Moderate | Very low | Very low |
| (localized) | | | |

The main significance of a bacterial infection like Legionnaires Disease is a new appreciation for the amazing airborne transmission risk of bacterial infection. Many physicians were of the opinion that bacteria and virus once airborne are innoxious. The significance of the bacterium Legionnella pneumophilia and its mal-culture under certain conditions, as in air conditioning cooling towers, demands new respect for the airborne mode of transmission of this bacterial disease. Legionnella pneumophilia requires strict respiratory isolation. This pneumonia-like illness was first recognized after occurrence during a legionnaires conference at the Bellview Stratford Hotel in Philadelphia during July 1976 where 182 fell ill and 29 died. Evidence linked the seating position of the attendees to the infection origin. The exact mode of airborne transport is not at this time known although its was identified as relating to air-cooling towers.

Since that time (actually it has been established that cases occurred prior to that time) other infections have occured. During May 1980 one-on-one correspondence between airborne LPO was established in Burlington, Vt. where 22 cases were diagnosed and 6 died. A cooling tower upwind of the Medical Hospital was found to be contaminated. Late in June 1980 after discontinuation of chlorination of the cooling tower another epidemic occured at the same location involving 34 additional cases resulting in 8 additional deaths. In England, at Stafford General Hospital, 37 people lost their lives. Subsequent investigation showed that LPO could be traced to drip trays connected to the hospital's air conditioning equipment. Again the interest, in the present investigation, is not so much on avoiding culturing the bacterium as it is the airborne nature of transmission. Certain bacterial infections clearly have an airborne transport mechanism. Almost all viral infections are airborne.

Exotic Communicable Diseases

Exotic communicable diseases (ECO), such as Lassa Fever, Marburg virus disease, Ebola virus, Junis and Machupo hemorrhagic fevers are increasingly frequent outside their indigenous areas because of the ease of modern travel. Strict isolation, including respiratory isolation is proscribed for patients with these diseases because of their virulence. They are deadly. Ebola virus disease, clinically indistinguishable from Marburg virus disease, occurred in Sudan and Northern Zaiie in 1976. Of 237 cases reported, 211 resulted in death. In July 1978 in Southern Sudan, 33 reported cases resulted in 22 deaths; a mortality rate of 66.7%. These and other virulent ECD's, including pneumonic plague and smallpox, the most transmitable disease known, are kept in laboratory confinement throughout the world for possible use in bacteriological warfare. (A frightening thought!)

Human Pathogens as Particulates

Table 2 lists known commutable diseases transmitted by human contact listed by increasing viral and bacterial particulate size.

TABLE 2
Human Commutable Pathogens
(Sizes in Micrometers - μM)

| | | | | | |
|---|---|---|---|---|---|
| | | Rod | Rod or | | |
| | Microbial | Length | Cossus Dia. | | |
| Organism | Group | (μm) | (μm) | Source | Significance |

Viral Pathogens by Increasing Particulate Size

| | | | | |
|---|---|---|---|---|
| Parvovirus B19 | Virus | 0.022 | Humans | Filth disease, anemia |
| Rhinorvirus | Virus | 0.023 | Humans | Colds |
| Coxsackievirus | Virus | 0.027 | Humans | Colds |
| Echovirus | Virus | 0.028 | Humans | Colds |
| Togavirus | Virus | 0.063 | Humans | Rubella (german measles) |
| Adenovirus | Virus | 0.08 | Humans | Colds |
| Coronavirus | Virus | 0.11 | Humans | Colds |
| Morbillvirus | Virus | 0.12 | Humans | Measles (rubeola) |
| Parainfluenza | Virus | 0.22 | Humans | Flu |
| Paramyxovirus | Virus | 0.23 | Humans | Mumps |
| Varicella-zoster | Virus | 0.3 | Humans | Chickenpox |
| Chlamydia pneumoiae | Virus | 0.3 | Humans | Pneumonia |
| Yersinia pestis | Virus | 0.75 | Humans | Pheumonic plague |

Bacterial Pathogens by Increasing Particulate Size

| | | | | | |
|---|---|---|---|---|---|
| Mycobacterium Tuberculosis TB | Bacteria | 1.0-4.0 | 0.2-0.5 | Humans | Hard swelling of body tissues |
| Mycoplasma pneumoniae | Bacteria | | 0.25 | Humans | Pneumonia |
| Bordetelle pertussis | Bacteria | | 0.25 | Humans | Whooping cough |
| Haemophilus influenzae | Bacteria | | 0.43 | Humans | Meningitus, pneumonia |
| Streptocorcus pyogenes | Bacteria | | 0.6-1.0 | Humans | Causes pus forming infections, |
| | | | | | scarlet fever, pharingitis |
| CardiobactOrium | Bacteria | | 0.63 | Humans | Opportunistic infections |
| AlkafigeneO | Bacteria | | 0.75 | Humans | Opportunistic infections |
| Neisseria meningitidis | Bacteria | | 0.8 | Humans | Meningitis |
| Staphylococcus Aureus | Bacteria | | 0.8-1.0 | Humans | Causes pus forming infections, |
| | | | | | opportunistic infections |
| Streptococcus pneumoniae | Bacteria | | 0.9 | Humans | Pneumonia, otitis media |
| Corynebacteria diphtheria | Bacteria | | 1.0 | Humans | Diphteria |
| Actinomyces israelii | Bacteria | | 1.0 | Humans | Antinomycosis |
| Haemophilus parainfluenzae | Bacteria | | 1.0 | Humans | Opportunistic infections |
| Moraxella lacunata | Bacteria | | 1.0 | Humans | Opportunistic infections |
| Moraxella catarrhalis | Bacteria | | 1.3 | Humans | Opportunistic infections |

Note:
Most pathogenic particulates are above 0.1 μm in size. None are below 0.01 μm in size.

Minienvironments

Cleanroom enclosures, fumehoods, isolation bubbles, hoods and other type enclosures, generally called minienvironments, have been disclosed in the patent literature to attempt accomplishing separating a determined zone from outside atmosphere. Laboratory operations, especially in the medical field often require that workers be provided with standalone laboratory hoods generally isolating the individual from hazardous material therein. A particular problem with enclosures of this type is the ingress of hazardous particulates to a patient or the egress of hazardous agents to a physician or laboratory worker allowing possible infection. Minienvironments do not generally protect the worker from emissions when the hood is opened to allow access.

Protective enclosures, using powered air respirators are known but these require bulky equipment are not designed to be conveniently carried and rapidly deployed. They are not portable. A full body isolator with complete internal gas conditioning, filters, and sterilizers is shown, for example, in U.S. Pat. 6,321,764 B1 to Gauger, et al, (Nov. 27, 2001). Isolators of this type are generally not portable. Where portability is desired further requirements arise.

Microenvomiments

Facemasks, body coverings, hoods, and similar apparatus have been disclosed in the patent literature to attempt accomplishing a separated determined zone from outside atmosphere for individual use. Four general respiratory device types are known in the art for providing conditioned respiratory breathing and/or combating airborne hazards for individual use. The following are examples of “microenvironments” disclosed in the patent literature:

Facemask Particulate Filters

The first is the respiratory filter type, represented, for example, by U.S. Pat. No. 6,216,693 issued to Rekow et al, Apr. 17, 2001 wherein a particulate filter surrounds the nose and/or mouth and where the user by forced inhalation draws in outside air through the oral/nasal covering filter. Masks of this type are generally simple and portable, designed to filter outside air of particulates before breathing. A continuous seal around the users mouth and nasal regions is necessary. Conventional particulate mask configurations using mask-to-face sealing is attained in many instances only with considerable discomfort for the user. Particulate filter facemasks are particularly uncomfortable because of high breathing resistance, impaired voice communication, increased thermal stress and the further discomfort of tight-fitting straps, especially when the mask must be worn for prolonged periods. It is impossible for the user to eat without removing the mask.

A second known type is the mouth and nasal covering mask additionally having access to conditioned air or gases piped into the mask as exemplified, for example, by U.S. Pat. No. 6,966,317 B2 issued to Bardel et al, Nov. 22, 2005; U.S. Pat. No. 5,555,879 to Helin et al, Sep. 17, 1996; U.S. Pat. No. 5,413,097 to Birenheide et al, May 9, 1995; and U.S. Pat. No. 5,394,870 issued to Johannson, Mar. 7, 1995. Masks of this type generally do not allow portability because the apparatus providing conditioned air or gases piped into the mask is usually fixed and bulky. Patient respiratory type masks are generally used in the treatment of respiratory conditions and sleep disorders (e.g., obstructive sleep apnea) by delivery of a breathable gas to assist patient respiration. These patient respiratory masks typically form a chamber formed by the walls of the mask and the user's face. Generally, a gas supply line delivers gas into an aperture aligned with the wearer's nostrils. The walls of a patient respiratory mask are usually semi-rigid whereas the face-contacting portion comprises a resilient elastometric material conforming to various facial contours. This type mask is normally secured to the wearer's head by straps. The straps are adjusted to pull the mask against the face with considerable force to achieve a gas tight seal between the mask and the wearer's face so that gas may thus be delivered to the wearer's nasal passages.

Problems often arise with masks of the above configuration. The mask may become dislodged, thereby breaking the seal between the mask and wearer. This may occur if the wearer rolls over when sleeping thereby creating a pulling force on the supply line sometimes transmitted to the mask and breaking the seal. When a mask of this type is used for treating the condition of obstructive sleep apnea by administration of Continuous Positive Airway Pressure (CPAP) treatment, a leak can result in the pressure supplied to the entrance of the wearer's airway being below the therapeutic value, and the treatment becomes ineffective. Another problem is the face-contacting portion may apply excessive pressure to the wearer's face resulting in discomfort and possibly skin irritation. This can occur because the face-contacting portion has to distort beyond its normal range of elasticity to conform to certain facial contours requiring the application of excessive forces. In certain cases excessive pressures may increase wearer discomfort, resulting in facial soreness and ulceration.

A third type is the respiratory hood with access to conditioned air or gases piped into the hood as exemplified for example by U.S. Pat. No. 6,834,646 B2 issued to Alon et al, Dec. 28, 2004; U.S. Pat. No. 6,186,140 B1 to Hoague, Feb. 13, 2001; U.S. Pat. No. 5,819,728 to Ritchie, Oct. 13, 1998; and U.S. Pat. No. 5,265,592 to Beaussant, Nov. 30, 1993. Protective hoods of this type are usually powered air respirators requiring bulky equipment and not designed to be conveniently carried and rapidly deployed. They are generally not portable. They require skills and training in order to provide adequate protection.

Portable hoods, designed to protect a user from inhalation of hazardous materials are known which isolate the user from hazardous particulates, fumes, or aerosols but require skills and training in order to provide adequate protection. For example, U.S. Pat. No. 5,186,165 issued to Swann, Feb. 16, 1993; U.S. Pat. No. 5,113,854 to Disch et al, May 19, 1992; U.S. Pat. No. 5,009,225 to Vrabel, Apr. 23, 1991 are used for applications ranging from medical to warfare, sometimes requiring the user to wear the mask continuously for hours or perhaps even days. Unfortunately, the user will not generally tolerate an uncomfortable hood for these long durations and the intended protective, therapeutic or diagnostic objectives will not be achieved or will be achieved with great difficulty and at considerable user discomfort. In addition, these art-crafted respiratory hoods are relatively bulky and heavy equipments are generally required.

Often a user exposed to an unexpected toxic environment is untrained in safety procedures such as how to don and activate a powered air respirator hood, resulting in panic or at least degraded job performance.

Military Masks for Hazardous Protection

Respiratory protection apparatus currently used by military personnel for protection against chemical and biological contaminants impose additional substantial physiological and psychological burdens on the wearer because of the added stress of a hostile enemy. Military personal often require respiratory protection equipment during missions. Generally these hood assemblies are made of gas-impermeable hood and flexible material, designed to allow near immediate donning to a wide range of users when a positive-pressure respirator hood assembly is required. Hoods used as protection against hazardous agents are difficult to wear for prolonged periods because they are relatively bulky and heavy, have high breathing resistance, impair vision and communications, cause thermal stress, physical discomfort, and degrade military performance.

The demands placed on respiratory protection equipment for use by the crews of military vehicles: e.a., land and/or sea vehicles, are even greater due to the limitations on the size or bulk of such crew masks in crowded crew cabins, and the need to avoid fogging of the lenses plus crew- person exhaustion from heat buildup, physical discomfort and/or respiratory effort.

Generally, protective hoods of the military type contain a transparent visor, a gas treatment unit comprising a filter for filtering particles, aerosols, toxic and noxious gases etc., a power-operated blower to generate a positive pressure within the hood, and a one-way purge valve for facilitating the exhaust of exhalation gases and moisture from the hood. The hood is generally provided with a sealing portion for securing the hood over a body portion of the user.

Previous efforts to provide crew masks include the U.S. Army M45 (Aircrew) and N42 (Combat Vehicle) masks. However, the M45 has no powered blower system due to weight and logistic concerns. While the M45 provides adequate protection and defogging properties, this crew mask is reported to be very uncomfortable when used in combination with helmet systems due to the harness buckles and the presence of the intern seal in the forehead area, where a crew helmet can press the seal into the forehead. In addition, the lack of a powered blower system results in high breathing resistance, adding to crew fatigue. An example of the respiratory mask of this type is U.S. Pat. No. 6,112,746 issued to Kwok et al. Sep. 5, 2000 where over 200 references to prior art of this type are listed.

In an alternative approach, the U.S. Air Force AERP mask system eliminates the face seal, in favor of a neck seal design. In addition, both the U.S. Army M48, IM49, and the U.S. Air Force AERP use a dual canister blower system providing the overpressure needed for protection against inward diffusion of toxic agents, and to provide additional airflow for keeping the visor free of moisture or fog. Existing blowers are built to provide for airflow rates of approximately 4 cubic feet per minute.

Thus there remains a need in the art for a crew mask of optimized size and bulk with visor defogging while providing user comfort while at the same time providing protection against chemical or biological toxic agents during military missions and/or in the confines of a vehicle.

Physiological and Psychological Limitations of State-of-the-Art Microenvironments

Respiratory protection apparatus currently used by both civilian and military personnel for protection against chemical and biological contaminants impose considerable physiological and psychological burdens on the wearer. State of the art respiratory hoods can protect a user from inhalation of hazardous materials but for many of these crucial applications, ranging from medical to warfare applications the user is required to wear the mask continuously for hours or perhaps even days. There are generally both physiological and psychological problems with the user of respiratory isolation masks both of the mouth-nose particulate filter mask type and respiratory hood approaches.

Physiologically, there can be physical discomfort with conventional filter-type respiratory isolation apparatus by high breathing resistance, impaired voice communication, increased thermal stress, impaired vision, and discomfort wearing the apparatus for prolonged periods. Sometimes uncomfortable straps hold the mask tightly against the oral-nasal region of the face. It is impossible for the user to obtain food or drink without removal of the mask. Facemasks are impossible to wear properly with facial hair, sensitive skin, deep scars, or facial deformities. Facemask respirators protrude in front of the face, limiting visibility. They cannot be worn with full-face shields, welding helmets or similar safety equipment.

Space between the facemask and oral-nasal area results in dead air space, trapping exhaled air. Inhalation of this dead space air into the lungs removes oxygen further increasing carbon dioxide content. Exhaled air is hot and humid, condensing on the facemask. Continued exhalation into the dead air space further increases the retained carbon dioxide level increasing the probability of hyperventilation, cardiac stress and diminished capacity to perform work.

In the case of respiratory hoods relatively bulky and heavy equipments are necessary, all of which degrade job performance. The user consequently will not tolerate an uncomfortable hood for long durations and the intended optimum therapeutic or diagnostic objectives will not be achieved or will only be achieved with great difficulty and at considerable user discomfort.

Psychologically, because the mouth and nose are enclosed, breathing and communication is difficult and the fear of confinement may result in claustrophobic panic.

It is a major intent of the inventive disclosure presented herein to overcome these physiological and psychological respiratory protection shortcomings.

### SUMMARY OF THE INVENTION

The invention herein relates to a method for providing a mini/microenvironment, separating a determined zone from a surrounding space, while advantageously providing an access window. A particular embodiment of the present invention is a respirator hood assembly for personal use allowing maximum comfort for the user by eliminating direct solid covering of the mouth and nasal regions while continuing to provide barrier to outside particulates and toxins. A particular embodiment is advantageously directed to providing an individual a portable microenvironment for respiratory protection when entering an area of hazardous airborne agents.

The application discloses a particular embodiment providing a protected window opening at the oral-nasal region as part of a respiratory hood enclosing a person's head thereby allowing considerable increased comfort for the user while still providing protection against hazardous airborne agents. By the invention high breathing resistance, impaired voice communication, increased thermal stress, and uncomfortable straps holding the device tightly against the nose and mouth are avoided. It becomes possible for the user to periodically obtain nutrients merely by use of a straw without removal of the hood. Relatively bulky and heavy equipments are eliminated and the apparatus can be worn for prolonged periods. Psychologically, because the mouth and nose are not restricted by a solid barrier considerably reduced fear of confinement and claustrophobic panic are avoided.

It becomes possible for the user to communicate by voice without attenuation by a solid covering over the mouth. It become possible to eliminate use of electronic equipment substituting for direct voice communication. It becomes possible for the user to obtain required nutrients periodically merely by use of a straw without removal of the hood. Bulky and heavy positive pressure equipments are eliminated and the apparatus can be worn for prolonged periods. Psychologically, without the restriction of a solid barrier over the mouth considerably reduced fear of confinement and claustrophobic panic are avoided.

### OBJECTIVES OF THE INVENTION

It is a main objective of the present invention to provide an effective fluidic barrier guarding a window portion of an enclosure thereby allowing access while assuring separation of interior atmosphere from outside ambient.

Another general object is to provide an effective minienvironment protecting a determined zone from an outside space allowing neither ingress nor egress of contaminating materials or substances.

A further general object is to provide an effective fluidic barrier to contaminating hazardous particulates while providing a window allowing unobstructed access by elimination of a solid covering while disallowing both ingress and egress of infectious particulates.

Further, it is an object of the present invention to address conditions affecting microenvironments with inventive structure designed to eliminate or minimize prior-art problems leading to greater comfort and safety for the user and consequently a greater likelihood that the user will wear the protective device and realize its benefits.

A main object of the present invention is to provide window access to a minienvironment without compromising hazardous protection.

It is a further object of the present invention to provide a protected microenvironment for portable use by individual users.

It is a further object of the present disclosure to provide a microenvironment for an individual user while eliminating direct solid covering of the mouth and nasal region by use of a fluidic barrier shielded window.

It is a further object to eliminate high breathing resistance in respiratory masks and hoods.

It is a further object to allow direct communication by voice eliminating attenuation by a solid barrier.

It is a further object to eliminate need for electronic equipment substituting for direct voice communication.

It is a further object to eliminate uncomfortable straps holding an oral-nasal faceplate tightly to this region of the face.

It is a further object to aid elimination of increased thermal stress in the oral-nasal region of the face.

It is a further object to allow the user obtaining nutrients without requiring removal of the respiratory protection hood microenvironment.

It is a further object to allow elimination of the need for bulky and heavy positive pressure equipments for microenvironments.

It is a further object to provide microenvironmental apparatus that can be worn for prolonged periods.

It is a further object of the invention to provide a respiratory protection microenvironment containing conditioned breathing air by filtering and sterilization.

It is a further object to reduce overall weight and bulk, all of which degrade job performance,

It is a further object to considerably reduce fear of confinement for individuals using respiratory microenvironments.

It is another object to reduce psychological fear and claustrophobic panic for individuals using respiratory microenvironments.

Another objective is to provide maximized comfort for the user of respiratory microenvironments.

A final objective of the invention is to address problems with prior art with an inventive structure designed to eliminate or minimize each problem leading to greater comfort and safety for the user with consequent greater likelihood that the user will wear the protective device and realize its benefits.

Aerodynamic Phenomena Relating to the Invention

By means of the principles of fluid dynamics, including the phenomena of entrainment, laminar flow, attachment, and the Coanda Effect, a fluidic curtain can advantageously be made a useful barrier to both molecules and particulates outside the fluidic barrier by providing a laminar flow fluidic sheet separating one atmosphere from another. This raises the possibility of advantageously separating two zones, one side of the fluidic barrier from the other side.

To understand how the invention works, some explanation of aerodynamic principles relating to the function of the apparatus is required. These phenomena include “molecular dynamics”, “viscosity”, “laminar flow”, “Reynolds Number, “entrainment”, “turbulence”, “attachment”, and the Coanda Effect”

The term “viscosity” refers to the tendency of molecules to adhere together. Flow resistance of liquids like motor oil or honey show high viscosity. Gases like air show very low viscosity. For liquids, viscosity decreases as temperature rises because thermal agitation loosens the intermolecular bonds. However, for loosely packed molecules such as found in gases such as air, where the molecules are normally greatly separated and intermolecular attraction is insignificant, increasing temperature causes greater random thermal motion thereby increasing momentum coupling between differing velocities by molecular movement, and so viscosity increases. It is molecular attraction forces and Newtonian molecular dynamics that describe these phenomena.

Osborne Reynolds (1842-1912) while studying flow in pipes studied the tendency of a fluid to change from smooth flow and develop “turbulence”. He found that the tendency to develop turbulence was related to the velocity of the fluid, i.e., the greater the velocity the greater the tendency to turbulence; the length of the flow path, the longer the flow distance in the pipe the greater the tendency to create turbulence; the fluid density, whereby the higher the fluid density the sooner turbulence occurs; and that the higher the viscosity of a fluid where the intermolecular attachment is higher, like molasses, the less likely turbulence develops. He related all these factors into a mathematical expression known as Reynolds number:
Re=ρvl/μ 1)

In this expression Re is Reynolds number, ρ is fluid density, v is flow velocity, l is length of path and μ is fluid kinematic viscosity. The higher the Reynolds numbers the greater the tendency to develop turbulence. Thus for the gas curtain the molecular velocity should be as high as possible to induce maximum directed impact to the particulates but not so high as to induce turbulence to the fluidic stream because then the molecular impacts are no longer uniformly directed.

Air consists mostly of empty space. A volume of air at normal conditions is only about 0.1 percent occupied by molecules of nitrogen and oxygen, plus the other minor gases. Even so, the average tiny air molecule travels only about two millionths of an inch before colliding with another air molecule. Constantly in random colliding motion of all directions, these air molecules have an average speed, at room temperature, of about 1,500 feet per second. Under static conditions their average velocity in any direction is zero because their average molecular speeds are equal in all directions.

Suppose fluidic pressure is applied and a ten miles per hour wind develops. Then we regard the air as being in motion. In this case the average molecular velocity is about 15 feet per second in the wind direction, although average molecular speed, at room temperature, would still be in the neighborhood of 1,500 feet per second.

FIG. 1 (Prior Art) shows a 3-dimensional view of a conventional nozzle 100 from which an air jet sheet 101 is blown issuing horizontally with constant speed V. Any directed fluid stream like this is made up of molecules having varying directional vibrations but generally having momentum in the forward direction. These directed molecules impact molecules immediately outside the directed fluidic stream in the surrounding ambient. Outside molecules and particulates become “entrained” because of these directed molecular impacts, that is, they are directed into the same general direction as the molecules of the fluidic stream. Thus molecules and particulates outside the directed jet stream can be made part of the directed stream. As a consequence a uniform fluidic stream can act as a barrier to particulates. This phenomenon of “entrainment” is caused by molecular impacts and can generally be described by Newton's Laws of motion and momentum. Entrainment is the basis for other important phenomena relating to an effective fluidic barrier.

Because of random directional differences of the molecules issuing at the mouth of nozzle 100 the shaped air sheet 101 soon diverges and generally becomes of less and less uniform direction because of differences in the factors affecting the Re equation. This divergence, as shown in FIG. 1, whereby the fluid stream becomes thicker until random disturbances cause microflows in the fluid stream, eventually causing the phenomena of “turbulence”. At this point the shaped fluidic stream can no longer impart directed molecular momentum to molecules and particulates outside the directed stream and the fluidic barrier can no longer act as an effective barrier. Consequently, turbulence must be avoided and the fluidic bridge has to be collected prior to development of turbulence if it is to be effective as a particulate barrier.

For the purposes of an effective particulate barrier the gas molecules constituting the fluidic stream should all be of uniform velocity, i.e., having momentum all in one direction. Turbulence should be avoided. In fluid dynamics this is generally called “laminar flow”, or flow of uniform speed in one direction. One widely recognized expedient for reducing turbulence in a liquid stream to aid laminar flow is to introduce a turbulent liquid stream into an enlarged chamber. This aids reduction of random localized flow velocities in the liquid fluid stream. This is possible because the viscosity is higher than for a gaseous stream. For gaseous fluids like air this is more difficult because of low viscosity and random microflows at the laminar flow transition to turbulent flow occurs at Reynolds number about 2500. Thus, providing laminar flow for a gas barrier curtain requires more efficient means. FIG. 2 and FIG. 3 show how this may be accomplished.

FIG. 2 shows a 3-dimensional view of a gas sheet similar to FIG. 1 jetting from nozzle 100. By means of the Coanda Effect the directed flow of fluidic sheet 101 issuing from nozzle 100 can be made more laminar by the use of the phenomena of “attachment”, or the “Coanda Effect”. As was shown in FIG. 1, because of the phenomena of entrainment, i.e., the capture of molecules from the ambient into the fluid stream, a localized reduced pressure region forms immediately around fluidic sheet 101 in the regions of laminar flow. This reduced pressure has consequences. It is the cause of “attachment”, or Coanda Effect which is the attraction of the fluidic sheet to follow around a curved surface. Again the “momentum” theory of Newton's laws of motion best describes the phenomena although Bernoulli Theory can also be used.

Referring to FIG. 2, at the exit of nozzle 100 assume a curved surface 102. Air sheet 101, ejected horizontally from a nozzle 200 with speed represented by vector v flows tangentially to curved surface 202. Air, having mass, tries to move in a straight line in conformance with the law of conservation of momentum but the pressure in the ambient outside directed flow sheet 101 is atmospheric and that immediately adjacent airstream 101 at the curved surface 102 is atmospheric minus ρv/R where ρ is the density of the air.

FIG. 3 shows the steady state Coanda effect dynamics in side view. As the air is continually carried away, the reduced pressure line at 103 continues to form in front of the gas jet sheet 101 emitted from nozzle 100. The pressure differential line 103 continues to force the gaseous fluidic stream down, bending by “attachment” to match the shape of the Coanda surface 102. The original contact point 103 continues to move far to the right in conformity with Coanda surface 102 as air is continuously being pulled away because the localized reduced pressure continues to pull the jet sheet toward Coanda surface 102 by the phenomena of attachment. Thus the jet sheet is forced to continually match the shape and direction of the Coanda surface 102 until finally surface friction forces reduce the local speed so much that reduced pressure is no longer formed. Finally so much surface friction develops immediately between the Coanda plate 102 and the air jet stream 101 that finally the fluid stream detaches. At this maximum point of attachment the contact point has moved furtherest to the right on Coanda surface 102. This attraction occurs both because of the reduced air pressure at this localized line 103 but also because of the friction force of the air. Thus the airflow sheet 101 is attracted to and attached to surface 102. By means of the Coanda effect enhanced laminar flow of the jet sheet is accomplished. A surface like 102 will hereinafter be called a “Coanda surface”.

In wing design these total phenomena are extremely important because the moving air attached to the Coanda surface of a wing after the leading edge provides reduced pressure above the moving airstream for a longer time before turbulence occurs. Thereby the total wing lift is considerably increased. If the air stream detatches too soon; the wing begins a stall.

A further consideration of a Coanda surface is shown in FIGS. 4A and B. FIG. 4A illustrates a Coanda plate 102 below fluidic stream 101 of velocity v emitted from nozzle 100. In this case the molecular momentum forces of the stream, vectored as shown, show forward momentum forces tending to detatch the stream from the Coanda surface. FIG. 4B illustrates a Coanda plate 102 above a fluidic stream with similar velocity v. In this case the molecular momentum forces of the stream, vectored as shown, show forward momentum forces tending to increase attachment of the stream toward the Coanda surface 102.

### BRIEF DESCRIPTION OF THE DRAWINGS

FIG. 1 shows fluid emitting from a conventional nozzle.

FIG. 2 is a perspective view of fluid emitting from a conventional nozzle with an added Coanda plate.

FIG. 3 is a side view of FIG. 2 showing in detail the separation point between the fluid stream and the Coanda plate.

FIG. 4A shows a side view of fluid attached to a lower Coanda plate showing the orthogonal vectored momentum magnitudes.

FIG. 4B shows a side view of fluid attached to an upper Coanda plate showing the orthogonal vectored momentum magnitudes.

FIG. 5 is a 3-dimensional side view of fluid attached to a lower Coanda plate showing [vector] a detailed section of the general structure [showing] and the window section of the invention but without inclusion of a complete enclosure.

FIG. 6 is a general three-dimensional view illustrating a respirator hood cartridge, with oral-nasal window, particulate filters, and blower system used to provide an individual protection from hazardous outside particulates.

FIG. 7 shows a side view of an individual using the respiratory hood.

FIG. 8 is an isometric drawing illustrating use of the respirator hood cartridge used by an individual, covered by a helmet.

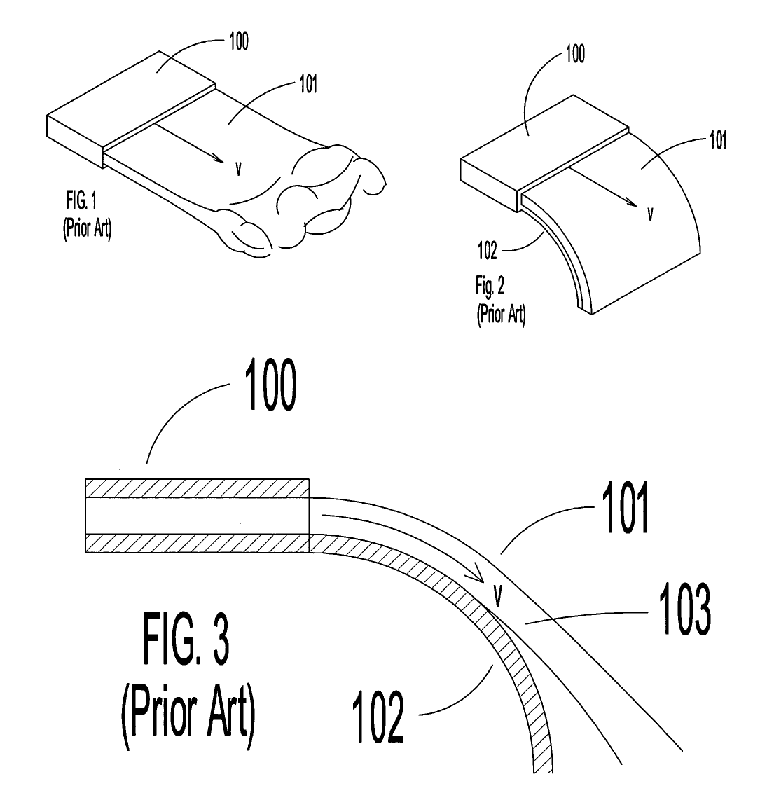

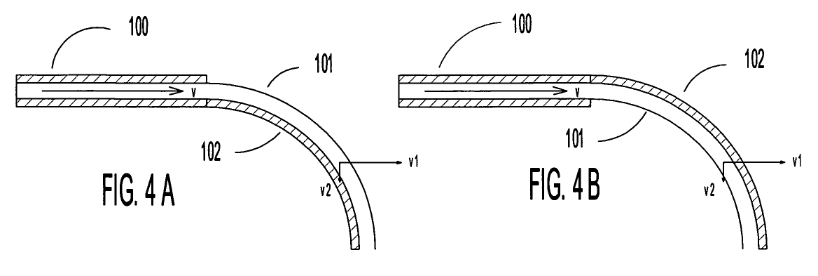

### DETAILED DESCRIPTION OF A PREFERRED EMBODIMENT OF THE INVENTION

The invention herein described is advantageously designed, by means of the physical phenomena of entrainment, laminar flow, attachment, and the Coanda Effect, to provide a fluidic curtain of properties useful as an effective barrier to both molecules and particulates each side of the fluidic stream barrier. By means of the invention it advantageously becomes possible to separate two zones of differing atmospheric content, separating the atmosphere one side of the fluidic barrier from the other side. Thereby the laminar flow fluidic barrier can be used to separate one atmosphere from another.

In order to understand the invention and to see bow it may be carried out in practice, a preferred embodiment will now be described by way of non-limiting example only, with reference to the accompanying drawings, in which:

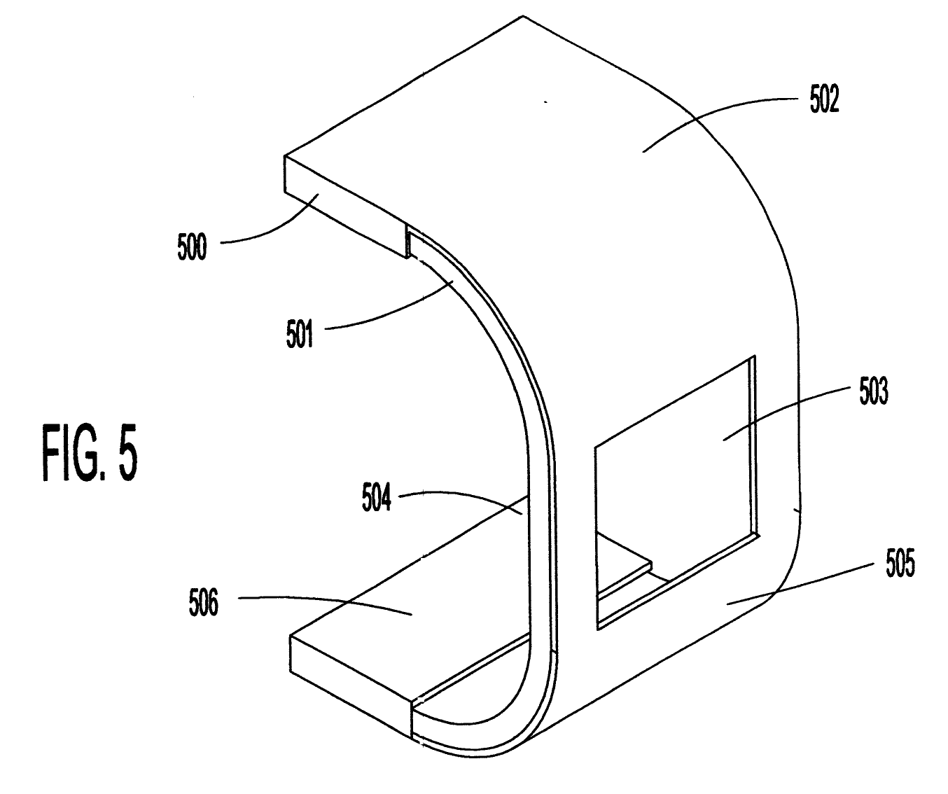

FIG. 5 illustrates the inventive concept used to provide a fluidic curtain over a window opening. The fluidic (i.e., gas or liquid) stream output nozzle 500 provides a fluid stream 501 of velocity v. Upper Coanda plate 502 above the stream shapes the stream aiding laminarity until fluidic stream 501 issues as smooth and well-defined flowing behind window 503. By combination, output nozzle 500 and Coanda plate 502 act to provide an effective fluidic emitter. Fluidic stream 501 is effectively sealed at the sides of window 503 by regions 504 which provide flow attachment. Before turbulence develops a second Coanda surface 505 directs the fluidic stream into collector duct 506.

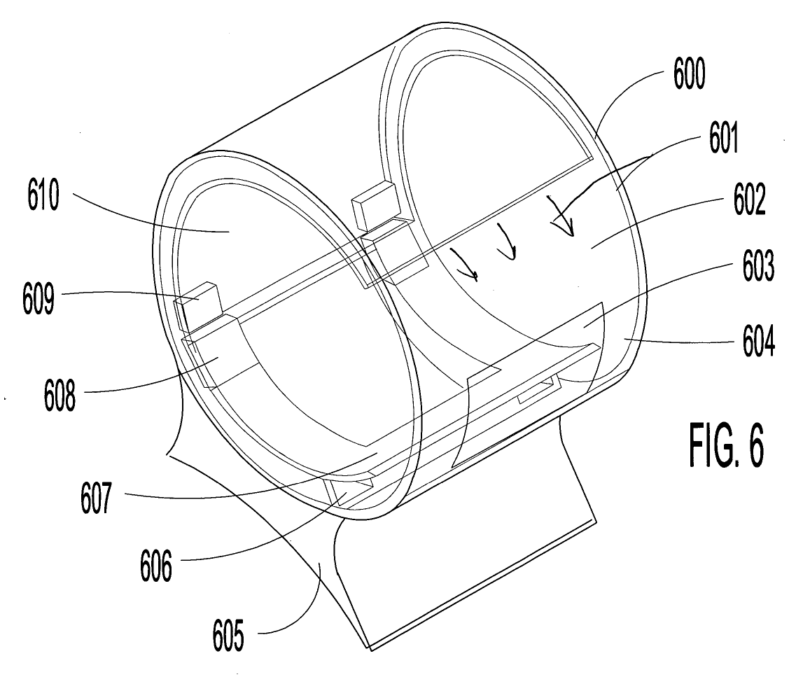

Of course the fluidic window curtain shown in FIG. 5 needs to be part of an enclosure to actually effectively separate one atmosphere from another. FIG. 6 shows such an enclosure wherein a practical embodiment of the invention is shown providing a microenvironment for respiratory protection.

FIG. 6 shows an embodiment of the invention where the principles advantageously provide a cartridge-type microenvironment providing a very effective barrier to particulates and toxins without the constraint of a solid covering at a window area thereby providing considerable advantage for the individual user. As previously shown in FIG. 5, by causing a fluidic stream to follow a Coanda surface, compactness and effective economics of construction is allowed for forming a smooth, well-defined, laminar flow sheet descending to protect a window opening to a protective environment. The smooth viscous flow, resulting from the homogeneous predetermined arrangement of uniformly directed velocity thereby achieving laminar flow yields a continuous uninterrupted gaseous sheet. Thereby, conventional elongated carefully profiled throat structure nozzles as disclosed in prior art are made unnecessary.

FIG. 5 described a novel application of the present invention utilizing fluid dynamics phenomena including use of a substantially laminar fluid stream, the phenomena of entrainment, attachment, plus the use of the Coanda Effect presenting an invention providing separation of a determined atmosphere zone from a surrounding space, providing protection against particulate agents entering or leaving the enclosed zone, without the requirement of a continuous solid barrier. Desirable conditioned air inside a microenvironment can thereby be kept separate from outside hazardous air by the application of the concepts disclosed in the present invention.

A conditioned zone of the larger type, bounded by a solid enclosure but with a window opening protected by a fluidic curtain comprised of a substantially laminar fluidic sheet of such speed along such direction that said sheet acts as barrier to ingress of particulates through the window will be called a “fluidic curtain bounded minienvironment”. A protected zone of the smaller type, for example for personal respiratory protection for individual use, will be called a “fluidic curtain bounded microenvironment”.

The particular embodiment of the invention to be described by FIG. 6 provides a laminar fluidic (i.e., air) curtain of the microenvironment type for providing barrier to ingress and/or egress of particulates over a window opening of size accommodating the mouth in an otherwise solid enclosure. Thereby speaking and eating are not hampered, yet NBC protection is provided.

Infectious agents like bacteria, toxins, or viral pathogens are particulates. They float around in the air and mainly induce respiratory illness by entering the nasal passages. Compared to the size of the air molecule these particulates are huge. The smallest known viral pathogen parvovirus B19 is only 0.022 microns in size. The largest known bacterial pathogen moraxella catarrhalis is 1.3 microns in size. Thus particulates of the hazardous type range from about 50 to more than 1,000 times the size of the air molecule. Even endotoxins are larger. Thus a directed air stream of uniform molecular direction can act as a very effective barrier by directed molecular impacts keeping outside particulates from the protected space. When this is combined with a continuously sterilized fluidic stream source the respiratory protective properties become impressive.

The following describes in detail the comfortable, easy to use respiratory hood that is an embodiment of the present disclosure. The hood is designed to use a laminar flow barrier across the mouth and nasal areas so that breathing is easy, there is no auditory barrier, the hood is easy to don, requires no training for use, and is automatically activated for operation. These and other features will now be described.

It is not sufficient to simply blow air across a window opening. An effective gas curtain barrier over a window opening requires a continuous smooth flowing sheet of gas of specific fluidic properties if the user is to be protected from ingress of hazardous agents from the outside atmosphere. The above described description discloses how the invention uses a controlled gas sheet acting as an effective barrier to outside particulates and toxins thereby protecting the user while not restricting solid covering where access is required.

FIG. 6 shows the general form of the inventive apparatus to accomplish providing a fluidic curtain barrier of the microenvironment type for an individual's respiratory protection. This apparatus form is generally applicable to formation of any fluidic barrier of the gas or liquid type and in this embodiment is shown as a self-contained cartridge surrounding which normally an added protective helmet may be added. Fitted over the head of the user, neck fitting 605 is designed to assure a totally sealed enclosure.

The invention comprises at least one fluidic emitting manifold or nozzle plenum generally shown as 600. From nozzle 600 fluidic stream 601 is emitted then attached to Coanda surface 602 which provides improved laminar flow to stream 601. The fluidic stream thereafter crosses behind window opening 603 while window side surfaces 604 seal the stream 601 to the edges of the window 603 by means of Coanda attachment. Below the window another Coanda surface directs the fluidic flow stream 601 for collection into ducts 606, aided by collector projection 607.

After crossing the window, the fluidic stream 601, aided by projection 607, is directed to collector ducts 606 both sides of the Coanda mask. Negative pressure is provided in ducts 606 by battery driven fans 609 which also pressurize the air emitting from nozzle plenum 600. At the output of ducts 606, prior to entering the fluidic emitter plenum, the collected air is sterilized and all possible remaining particulates are removed by use of filters 608.

For air, to insure proper dynamic action of and prevent leakage of contaminating agents through the fluidic gas curtain, the speed of the air stream forming the curtain sheet should not fall below approximately 2 m/sec as it enters the collector manifold. For this reason a speed between 2 and 20 m/sec. is optimal. Depending upon the size of the apparatus and fluid flow conditions the fluid gas stream thickness will generally have a mean value lying between 0.2 for microenvironments and 5 cm for larger-sized protected-zone minienvironments. The length and width of the fluidic stream will vary according to the nature of the window to be covered. For a protective hood for an individual user, where a window opening no bigger than the mouth is required, the width might generally be about 3 inches and the height about 2 inches, which is more than enough required for accommodation of the mouth for speaking and for using a straw.

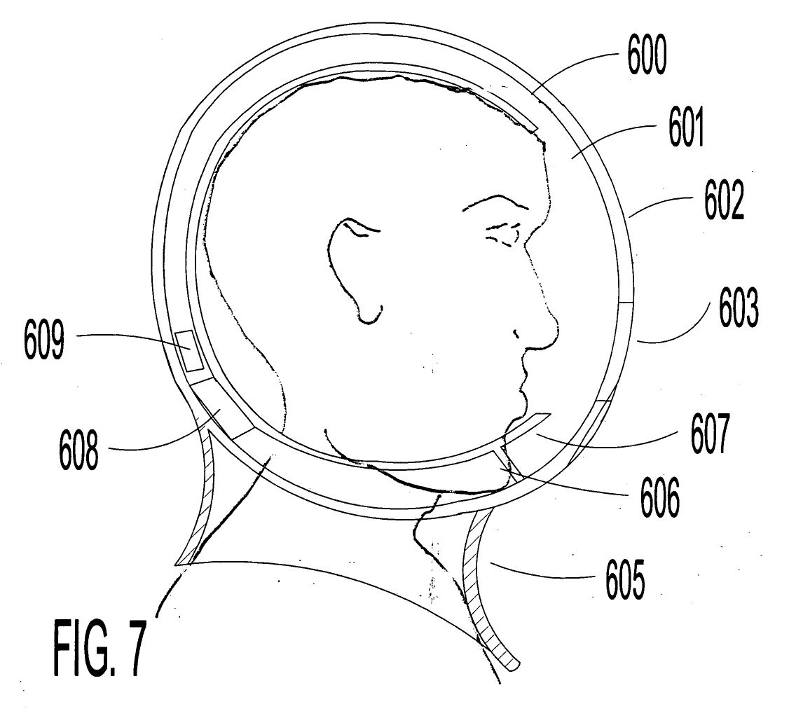

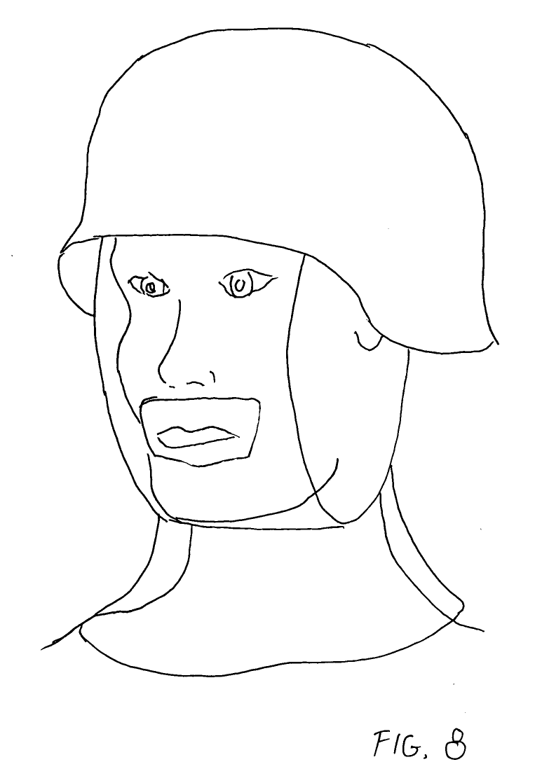

FIG. 7 shows a side view of the respiratory microenvironment cartridge for a user, using the teachings of the invention, wherein air entering fluidic collector manifold projection 607, positioned below the mouth of the user, guides air to be collected into ducts 606. Ducts 606 act by reduced pressure, caused by fans 609, drawing air into the ducts. In turn fans 609 force air flow around the top of the head of the user thereby recirculating air flow again into nozzle plenum 600 forming fluidic sheet 601. In combination nozzle 600, Coanda surface 602, and fluidic sheet 601 constitute the fluidic emitter manifold.

Fans 609 are powered by batteries contained within. Filtering and sterilization package 608 assures removal of particulates so that air breathed by the user is of respiratory quality. Sterilization apparatus such as ultraviolet light may be added if further assurance that breathable air completely free of pathogens is available. UV LED's, requiring very little electrical power, make practicable such pathogenic sterilization capability when added to the filtering and sterilization package 608. If further respiratory air conditioning is desirable, such as for moistening and possibly cooling and heating, these capabilities can also be added to provide even greater comfort for the user.

By recirculation, the collected air is kept free of outside particulates by repeatedly passing the collected air through filters and sterilizers thus assuring that any possible small amount of outside particulates in the barrier stream are kept from entering the breathing zone of the user. Advantageously, within the microenvironment, personal protection from exterior particulate hazards is thereby provided while the benefit of the mouth region being free allows both speaking and eating.

FIG. 8 shows a respirator hood cartridge with an added steel helmet for military use. The window opening 603 is shrouded by the fluidic curtain barrier. Filtering assures removal of particulates so that air breathed by the user is of respiratory quality. By recirculation, the collected air is kept free of outside particulates by passing the collected air through filters and sterilizers thus assuring that any possible small amount of outside particulates in the barrier stream are kept from entering the breathing zone of the user. Advantageously, within the microenvironment personal protection from exterior particulate hazards is provided while allowing the benefit of the mouth region being unrestricted.

Breathing Pressure Accomodation

In conventional personal respiratory equipment of the covered oral/nasal type, the pressure inside the mask varies relative to ambient pressure during cycles of breathing. Because of the closed system the suction caused becomes large while breathing in. The pressure exerted on the air decreases the volume of air. During breathing-out, the pressure exerted on the air increases with a corresponding air volume increase. This results in undesirable pressure peaks and troughs. For example, if the mean flow rate or “ventilation flow rate” is 30 I/min, and the peak flow rate that would be required of the blowers 609 would be about 100 I/min. However, if the buffer volume does not need to be greater than the ventilation flow rate, then the peak rate can be reduced to 30 I/mn. Consequently the power required of the electric drive motor for the blower can be divided by three or the operating time of a given electrical battery can be multiplied by three; the life time of filter cartridges is multiplied by three.

The presence of the Coanda plate makes it possible for the flow rate required of the blower to be reduced considerably by allowing the gas curtain to move in and out, without losing ability to act as a curtain barrier as breathing pressure increases and decreases. Consequently the amount of breathing effort that is required can be greatly reduced when the buffer volume required by conventional masks, lacking resilient means between its walls, can be considerably increased.

The Filter Package

This invention embodiment for personal respiratory protection relates to emergency safety equipment, particularly respirator hoods providing filtered air to persons in toxic environments. Herein, the term “hazardous materials” will refer to airborne materials of toxic and/or noxious gas or biological warfare agents, including particulates of inert, viral, or bacterial nature in fine spray condition or as aerosols, or droplets, that alone or collectively might be present in the air outside the respiratory hood. “Filtered and sterilized air” will refer to the conditioned air inside the respiratory hood from which residual hazardous materials have been removed as by passing the outside air through particulate filters, sorbent filters, a disinfecting section or combinations thereof.

The respiratory air within the microenvironment is designed to be continually recirculated and filtered. As shown in FIG. 6 air from inlet ducts 606 is passed through filters 608 powered by electric blowers 609. Two filters and two blowers, positioned on opposite sides of the cartridge unit, minimize bulk and volume. Accordingly the gas or air stream is passed through a filtering medium allowing retainment of microorganisms comprising a microfilter retaining particles of 0.2 micron and preferably in the range of 0.01 micron. Preferably, the compact filter unit has an airflow resistance of about 10 mm to about 30 mm of water at an airflow rate of about 50 liters per minute. The compact filter unit, optionally two-sided for optimum use of space, generally includes a particle filter element, e.g., a HEPA filter, an electrostatic and/or electret filter and possibly a further sterilization unit such as UV LEDs, For optimum efficiency and wearer comfort, the particle filter may be of electret type with a filtration efficiency similar to that of a HEPA filter element, when measured at an airflow of 50 liters per minute.

The particulate filtration media is made of any material suitable for trapping fine dust, bacteria, spores and the like, with a relatively low breathing resistance or back pressure. While a high efficiency particulate air (“HEPA”) filter element is readily employed, an electret or electrostatic filtration media, that is, a filter material with fibers comprising a permanent electric potential, for example, such as filters commercially available from 3M®, may also be used. The surface area of the particulate filter should be a minimum of 125 cm2 to 150 cm2 for optimal filtration with a low backpressure.

The compact filter element may optionally includes a material effective to remove undesirable chemical vapors, e.g., toxic vapors such as nerve gases or agents. For use against organic or organophosphate type toxic vapors or agents, a “packed-bed” carbon filter may be included. Other art-known adsorbents may optionally be included and/or substituted for a packed bed carbon filter when other vapor threats are present.

Additional sterilizing means may be included downstream, as by irradiation using UV LEDs in the location of the microfilter.

By removing conventional facemasks and filter cartridge from obstructing the wearer's vision, a definite improvement in safety to the operator is accomplished. Supporting straps and elastic bands around the head are eliminated, making it totally compatible with wearing a hard hat, winter clothing, safety equipment, adding greatly to convenience and comfort factors. The hood can be worn with large growths of facial hair, deep scars, deformed facial features, and does not irritate facial tissue whereas conventional mouth covering respirators fit uncomfortably close to the face. Advantageously the respiratory hood enables it to be worn with safety equipment, welding helmets, or full-face shields without restricting visibility of functionality.

The Blower

Blowers provide an air flow ranging from about 03 to about 2.0 CFM. While greater air flow rates may be optionally employed, this will lead to an increase in the weight, bulk and power requirements for the blower. Thus for optimal use under field conditions, the airflow is preferably no greater than 2 CFM.

A blower is operably connected to the filters, either within or external to the filter housing. Depending on the desired configuration, the blower may be positioned distal to the filter unit, so as to force air into the filter. Alternatively, the blower may be positioned proximal to the filter unit, so as to create a partial vacuum resulting in forced flow of ambient air through the filter. The blower includes any suitable low profile fan, impeller, rotary air pump, or the like, but preferably the blower includes a single axial fan system designed to minimize the overall profile of the blower. Generally, the blower is electrically powered, e.g., by low voltage direct current provided by a vehicle system and/or a portable power supply that comprises primary (disposable) or secondary (rechargeable) batteries, and/or any suitable portable source of electrical power, e.g., a fuel cell device. The low voltage direct current ranges, e.g., from about 6 to about 24 volts, sometimes dependant on the standard auxiliary power supply in a vehicle, and/or the desired weight and configuration of a power pack carried by a crew person. Alternative motive power for the blower could include, e.g., a vehicle engine vacuum system configured to turn the blower fan. For replacement, the filter-blower structure conveniently incorporates a rigid plastic housing that can be injection molded from any engineering plastic.

General Construction Requirements for the Respiratory Mask Cartridge

Referring to FIG. 6 again, the respiratory hood cartridge invention embodiment is a self-contained microenvironment respirator hood assembly comprising, a gas-impermeable hard shell enclosure comprising at least a portion which is a transparent visor, an inner matching hood made of configurable flexible material fitting the users head and spaced from the hard shell enclosure, a fluidic gas curtain covering a window in the otherwise solid enclosure, a gas treatment unit comprising a filter for filtering particles, fine spray' aerosols, and toxic and noxious gases etc. hereinafter called “hazardous materials', a power-operated blower to generate a positive pressure within the hood, and a sealing portion for securing the hood over the shoulder portion of the user. The hood assembly described is designed to allow near immediate donning to a wide range of users, requiring no training to don and operate the hood assembly.

Referring again to FIG. 6, the respiratory hood comprises an outside covering of liquid and gas-impermeable material and a soft inside shell, generally made of a flexible elastometric material whereby the hood outer shell is spaced from the soft inner shell by means of pillars. Within the space so formed air is recirculated and conditioned by a gas treatment unit attached to the hard outer shell. The outer shell includes a visor section positioned adjacent to the eyes of a user of gas-impermeable material of transparent clarity, high impact strength and dimensional stability suitable to provide the user visual clarity.

Still referring to FIG. 6, fastened to the hard shell outside hood is a sealing portion in the form of a collar or neck seal made of an elastic material such as silicone, polyurethane, latex rubber, etc., allowing easy donning and requiring no latches, straps, ties, or the like. The neck seal is of material such that it can snugly fit onto the shoulder portion of the user regardless of long or thick hair, beards, etc. such that the neck area is securely covered. Further, the neck seal is dimensioned to be wide enough for wearing comfort. For convenience, at donning, a pressure switch could be included such that circulatory air is automatically activated.

With this design, the respirator hood is easily and conveniently donned within seconds by a wide range of individuals without need for training or operating instructions.

A. The Hard Outer Shell Covering Material

The hard shell on the outside of the respiratory cartridge provide rigidity and some protection from impact and/or flying debris and the like. This rigid shell is optionally bonded to the elastomeric inner shell fitting around the head. The hard shell dimensions are selected to be slightly larger than the inner elastometric shell leaving an open space ranging in spacing from about 0.25 to about 1.00 inches, to allow air flow from the collector manifold to the emitter manifold. Advantageously, the hard shell allows secure attachment of other protective equipment such as filters, blower, and sterilization equipment as required to assure breathable air. The hard shell is attached to and spaced from the soft inner shell by means of pillars, columns, or supports allowing the proper spacing between the two.

The artisan will appreciate that the hard shell can be made of any suitable rigid material(s), such as a thermoplastic polymer and/or copolymer or composite material. Simply by way of example, suitable art-known polymer materials for the hard shell include polycarbonates, acrylics, polystyrenes, high density polyethylenes, and the like. Fiber-polymer composites are also contemplated for use in the manufacture of the hard shell to provide lightweight, impact-resistant protection. Materials of this type might include, for example, polymer or copolymer composites, such as epoxy polymers, that are reinforced with fiberglass, graphite fiber, aramid fiber, and/ or combinations of these, or similar materials. The hard shell can also be manufactured from lightweight metal alloy(s), including aircraft aluminum, titanium, and the like, and any other suitable art-known materials. The durometer of the hard shell might range, for example, from about 20 to about 60 Shore A hardness, but more typically has a hardness of 30 Shore A.

The viewing visor or lens region may be manufactured from any optically suitable transparent barrier material. The desirable properties of the selected visor/lens material are that it be optically clear, shatter and abrasion resistant, distortion free, and optionally capable of use with weapon sighting systems. By way of example, the visor can be made from any suitable transparent polycarbonate, acrylic, epoxy polymer or copolymer, etc. Preferably, the lens comprises a polycarbonate wherein aircrew helmet visors have typically been produced from polycarbonate material meeting the requirements of MIL-V-4351 and Fed. Spec-P393. Polycarbonate is noted for its clarity, high impact strength and dimensional stability. It molds well, and has very low shrinkage, including flame and abrasion resistance. Abrasion resistance can be further enhanced with the use of a protective coating in accordance with MIL-C-83409. Optionally, the lens may incorporate optical filter or partial reflective elements to reduce the transmission of undesirable wavelengths, e.g., ultraviolet, infrared or polarized visible light associated with reflective glare, as a photochromic and/or thermochromic coating or filter that darkens in the presence of undesirable levels of light and/or thermal radiation.

B. The Soft Inner Shell Head Covering

The soft inner shell head covering provides a closer fit over the head, although it is not necessary that all portions of the head be included. It is merely necessary that comfortable support be provided and that a continuous duct obtains from collector to emitter for the gas sheet curtain. A smaller duct space requires less airflow to ventilate and remove accumulated heat and moisture and advantageously keeps the visor free of moisture. The soft shell of the present embodiment is constructed to comfortably contact the upper part of the head, the side and back of the head, and forehead of a person wearing the respiratory mask cartridge. Unacceptable pressure on the forehead, particularly with a crew helmet pressing thereon has been reported with crew masks and is to be avoided. Overall, the soft inner shell ranges from about 0.045 to about 0.075 inches in thickness. Preferably, the inner shell elastometric thickness is about 0.060 inches. The inner shell is flexible and is molded from a silicone/organic rubber blend. Although other silicone and organic rubber materials (i.e., silicone, EPDM, butyl, thermoplastic elastomer) could be used, these materials offer the best overall properties for a flexible inner shell.

C. The Shoulder Seal

The sealing portion of the hard shell to the neck is an elastic seal generally of flexible material molded from a silicone/organic rubber blend. Although other silicone and organic rubber materials (i.e., silicone, EPDM, butyl, thermoplastic elastomer) could be used, these materials offer the best overall properties for a neck seal. A foam insert could optionally be used.

### SUMMARY

The respiratory apparatus herein described is comfortable, lightweight and easy to use, where donning is self-explanatory and no training is required for use. Natural breathing rather than forced breathing is a feature of the invention. The respiratory hood is designed such that protection from a toxic environment for users is provided whether male or female, regardless of facial or head features such as beard, hair length/thickness, eyeglasses, etc, and of user size ranging from toddlers to large adults. The design of the hood also allows it to be used to protect animals such as pets, livestock, etc. during possible airborne hazards.

The present invention addresses with simple design the problems that exist with respirators currently being used. By being more compatible and user friendly, the wearer will use the respirator longer without discomfort and be able to function in a safer manner.

The particular microenvironment embodiment of the invention provides a very effective barrier to particulates and toxins for the user without the constraints of a solid covering over the mouth area. By the invention the respirator hood acts as an effective barrier to outside particulates and toxins thereby protecting the user when entering a region containing hazardous particulates such as bacterial or viral infectious agents. By means of a fluidic sheet covering, a window is shrouded at the oral-nasal portion of the face shielding both ingress of particulates from outside the protective curtain barrier plus egress of possible infectious respiratory agents as from an infected person to the outside environment. Thereby an individual is both protected from outside airborne hazards while protecting others. The invention allows maximum comfort for the user eliminating direct solid covering of the mouth and nasal regions while still providing barrier to outside particulates and toxins. By the invention high breathing resistance, impaired voice communication, increased thermal stress and uncomfortable straps holding filtering material tightly against the nose and mouth are avoided. It becomes possible for the user to obtain nutrients merely by use of a straw without removal of the hood. Bulky and heavy equipments are eliminated and the apparatus can be worn for prolonged periods. Psychologically, because the mouth and nose are not restricted by a solid barrier considerably reduced fear of confinement and claustrophobic panic are avoided.

While a preferred construction in which the principles of the present invention have been shown and described in detail to illustrate the application of the principles of the invention, it is to be understood that the invention is not to be limited to these particular details but may, in fact, otherwise be widely embodied without departing from the invention described herein.

I claim:

1. A fluidic barrier for protecting a window opening in an otherwise solid enclosed structure, or minienvironment, comprising:
(a) a nozzle providing pressurized fluidic stream,
(b) a Coanda surface providing attachment of said fluidic stream to improve fluidic laminarity,
(c) said laminar fluidic stream directed symmetrically across window face of narrower opening width than said stream width,
(d) said window side faces attracted and sealed to fluidic stream by Coanda Effect,
(e) said stream thereafter collected by negative pressure duct(s),
thereby providing a fluidic barrier over a window separating an internal conditioned atmosphere from an external ambient without the imposition of a solid covering.

2. A minienvironment containing at least one window opening shielded each face by fluidic curtain of claim 1.

3. A minienvironment containing at least one window of extended casement depth wherein opposite ends of window openings are shielded by separate fluidic curtains of claim 1.

4. A minienvironment of claim 3 wherein fluidic curtains flow in opposite directions.

5. A respiratory protection hood, or microenvironment, comprising:
(a.) a hard shell outer enclosure over head of user with window located at oral-nasal portion of face,
(b) a soft inner shell generally shaped to users head and selectively spaced from hard shell by pillars,
(c) said hood fitted to users shoulders allowing sealed isolation from outside ambient,
(d) nozzle plenum providing positive pressure fluidic stream between outer and inner shells
(e) said stream directed onto Coanda surface providing attachment improving fluidic laminarity,
(f) fluidic stream directed across said window opening of narrower width than said stream,
(g) fluidic stream attracted to side faces of said window by Coanda attachment,
(h) said stream directed into negative pressure duct/s for collection,
(i) said collected fluidic stream pressurized by electrically powered impellors and ricirculated into emitter nozzle plenum,
thereby providing a window opening at users mouth region disallowing particulate penetration by means of recirculated gas barrier sheet protecting user from outside atmosphere.

6. A microenvironment for individual respiratory protection of claim 5 including a particulate filter pack.

7. A microenvironment for individual respiratory protection of claim 5 including an automatic quick-activation switch at donning.

8. A microenvironment for individual respiratory protection of claim 6 in cartridge form to allow use in a variety of helmet applications.
